(19) United States
(12) Patent Application Publication
(10) Pub. No.: US 2010/0219039 A1
(43) Pub. Date: Sep. 2, 2010

(54) ADAPTABLE CAR WASH MESSAGING SYSTEM

(76) Inventors: Mark G. Ringdahl, Chaska, MN (US); Harry Dilling, Biloxi, MS (US)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/781,141

(22) Filed: May 17, 2010

Related U.S. Application Data
(63) Continuation of application No. 11/324,708, filed on Jan. 3, 2006.
(60) Provisional application No. 60/640,972, filed on Jan. 4, 2005.

(51) Int. Cl. G06F 9/00

(52) U.S. Cl. 194/217

(57) ABSTRACT

A method of providing information to a user of a car wash is disclosed. The method includes receiving from a car wash one or more signals representing one or more payments. One or more signals are received from the car wash representing a value of one or more car wash functions purchased with the one or more payments. An indication is recorded of the value of the one or more car wash functions purchased with the one or more payments. The method also includes providing information that includes the indication of the value of the one or more car wash functions purchased with the one or more payments. Other illustrative embodiments pertain to a vending machine messaging device and a car wash.

The present application is based on and claims the benefit of U.S. provisional patent application Ser. No. 60/640,972, filed Jan. 4, 2005, the content of which is hereby incorporated by reference in its entirety.

### BACKGROUND

A variety of automatic vending systems dispense goods and services to customers in exchange for a deposited payment. One widespread example of an automatic vending system is a car wash. Car wash systems are used to wash, clean and vacuum automotive vehicles and other types of vehicles. Car wash systems include both fully or partially automated systems as well as systems which provide the functioning implements to be used by a user or customer in washing the vehicle. For example, some types of car wash systems are large systems in which a vehicle is pulled through a series of washing stations which automatically or manually provide various car wash functions, such as pre-rinse, wash, rinse, wax, etc. In another type of car wash system, the vehicle is substantially stationary while various car wash implements are automatically moved over the surface of the vehicle. In another example of a car wash system, washing liquids are dispensed through a spray gun that is wielded by a user, and various implements are provided to the user such as a foam brush, tire cleaner, etc., while the vehicle is parked in a bay.

Car wash systems, among other vending systems, often offer a variety of services with optional timing on each service. The car wash includes means to accept payment from a user of the car wash, in exchange for a certain amount of time that the car wash functions are dispensed, in one example. The amount of car wash function time purchased may be indicated by a timer that counts down while the car wash functions are being provided. After the user adds a form of payment, he can select from a variety of different services, and switch from one service to another at will, while the timer runs down. The amount of time allocated to each car wash function may also be variable, dependent on the value of the function. The amount of time that the car wash function is provided may be variably proportionate to different amounts of payment the user may choose to deposit. That amount of time will then count down as the user uses the car wash, freely switching between service options while the timer counts down to the end of the period of car wash function corresponding to the amount of payment input, in this example.

A user typically may try to divide her time proportionately between different car wash functions in an appropriate sequence, such as pre-rinse, then wash, then rinse, then wax, for example. The user will likely want to time her use of each of the functions so that she does not run out of time before finishing her planned sequence of functions—for example, by finishing rinsing and starting waxing just before the time runs out; or realizing after she has finished waxing that she still has a minute or two remaining, and could have used more time for the functions in sequence, but does not derive as much value out of trying to go back and repeat some of the functions after finishing her intended sequence. A user therefore typically finds it important to gauge the timing of her use of each of the services, in this sort of car wash.

However, the user is also motivated to spend his time concentrating his attention on actually washing his car rather than watching the timer run down. This may result in the inconvenience of the user trying to glance over his shoulder or crane his neck around from various positions around his car from time to time to try to catch sight of the timer and mentally calculate the time divisions between the different services so he can pace his activity appropriately, with his attention divided between actually washing his car and giving his attention to the timer. The timer may not be easy to interpret or even see clearly from a distance, or may be poorly placed relative to the car wash bay where the user's car is to be cleaned. Or worse yet, many car wash systems lack a perceptible timer monitor, and leave it to the user to try to gauge his remaining time on his own. This may result in the significant inconvenience for the user of trying to track his remaining time on his watch, for example, while trying to remember the starting time, as he progresses through washing his car.

These shortcomings are likely to frustrate and annoy customers of a car wash, and lower their satisfaction with their experience of using the car wash. This is likely in turn to motivate some customers to use other alternatives for getting their cars washed, and avoiding giving their business to the car wash. Owners of such a car wash are therefore likely to experience a decreased return on their investment due to the failure of some of the car wash's customers to enjoy and be satisfied with their car wash experience, and their corresponding lack of enthusiasm for returning frequently. There is therefore a compelling need for a way to make vending systems such as car wash systems easier to use.

### SUMMARY

Various embodiments provide a system for the operation of an existing car wash or other vending device to be learned and thereafter automatically provided to customers. For example, a system may learn how much time a car wash function is performed based on how much money is paid. This information may be provided to a customer in a variety of communicative formats, including voice messages.

One illustrative embodiment pertains to a method of providing information to a user of a car wash. The method includes receiving from a car wash one or more signals representing one or more payments. One or more signals are received from the car wash representing a value of one or more car wash functions purchased with the one or more payments. An indication is recorded of the value of the one or more car wash functions purchased with the one or more payments. The method also includes providing information that includes the indication of the value of the one or more car wash functions purchased with the one or more payments. Other illustrative embodiments pertain to a vending machine messaging device and a car wash.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter. The claimed subject matter is not limited to implementations that solve any or all disadvantages noted in the background. Various embodiments provide a wealth of additional and unexpected advantages, beyond the resolution of difficulties such as those noted above in the background. A variety of other variations and embodiments besides those illustrative examples specifically discussed herein are also contemplated, and may be discerned by those skilled in the art from the entirety of the present disclosure.

### BRIEF DESCRIPTION OF THE DRAWINGS

FIG. 1 depicts a vending machine messaging device, according to one illustrative embodiment.

FIG. 2 depicts a car wash, according to another illustrative embodiment.

FIG. 3 depicts a block diagram of a car wash, according to another illustrative embodiment.

FIG. 4 depicts a flowchart describing a method of providing information to a user of a car wash, according to another illustrative embodiment.

### DETAILED DESCRIPTION OF ILLUSTRATIVE EMBODIMENTS

As noted above in the summary, a variety of embodiments are contemplated, the variety of which may be initially illustrated by exemplary embodiments in the form of a vending machine messaging device; a car wash; and a method of providing information to a user of a car wash. Various embodiments disclosed herein deal with these and other illustrative embodiments, and provide some indications to the further variety of embodiments.

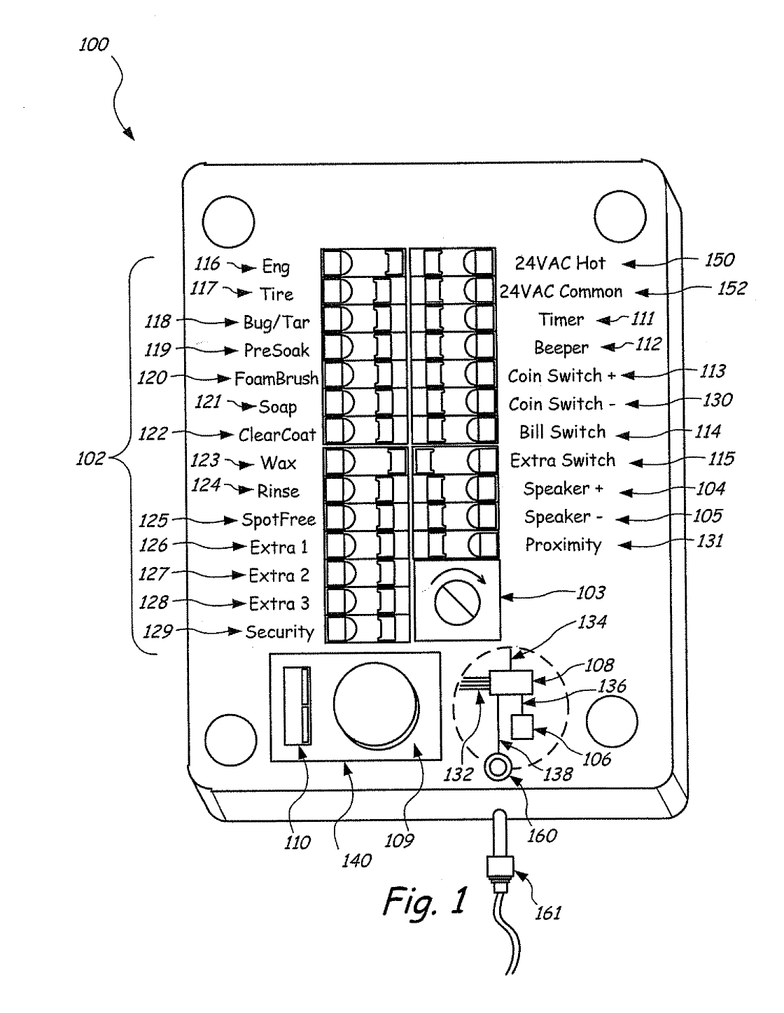

FIG. 1 depicts an illustrative embodiment of a vending machine messaging device 100. The vending machine messaging device 100 includes audio output 104 and 105, and an input array 102 of many inputs 109, 110, 111, 112, 113, 130, 114, 115, 131, 116, 117, 118, 119, 120, 121, 122, 123, 124, 125, 126, 127, 128, and 129 (individually identified below; collectively referred to as input 102). Messaging device 100 also includes a storage component 106 and a messaging controller 108, depicted in simplified block form in cutaway area 130, to indicate that they are internal to messaging device 100. Storage component 106 and messaging controller 108 may take any of a variety of particular forms, including several mechanisms currently and hereafter understood by those in the art to perform the functions disclosed for them, as further detailed below. The storage component 106 has voice messages stored on it. The voice messages include information related to a vending machine (not separately depicted in FIG. 1) with which messaging device 100 is compatible, which may be of any of a wide variety of types of vending machines. For instance, these may include car washes; snack and beverage vending machines; slot machines and other gambling devices; admission gates for paid parking ramps and lots; luggage cart dispensers; calling card dispensers; wired and wireless voice and data kiosks; gasoline, diesel, propane, and other fuel dispensers; and a variety of other types of vending machines.

The messaging controller 108 is in operative communication with the input array 102 through bus 132; with the audio output 104, 105 via signal line 134; and with the storage component 106 via signal line 136. The messaging controller 108 is configured to provide the voice messages to the audio output 104, 105 responsively to receiving signals from the inputs 109-129 of the input array 102, and to store and retrieve data, such as including voice messages, as well as signals received through input 102, on storage component 106. Audio output 104, 105 may be connected to a loudspeaker or other audio transducer component that translates an audio output signal into sound. Outputs 104 and 105 are both connected to the loudspeaker component to complete the audio output circuit. Messaging controller 108 is also connected to an input, illustratively depicted as an RCA jack 160, via signal line 138, and is configured to have a plug 161 of a microphone plugged in to jack 160, enabling controller 108 to receive audio samples and store them on storage component 106, such as to record new voice messages. Additionally, jack 160 can be used as an audio input to receive, for example, music. RCA jack 160, via signal line 138, can be configured to receive a plug 161 of an MP3, tape player, music source or audio source plugged in to jack 160, enabling the controller 108 to receive music or audio and directing to speaker output 104 and 105.

Inputs 109-129 are designed to be of particular applicability with signals from a vending machine such as a car wash, in this illustrative embodiment. Input 109 is a push button, and input 110 is a data port—in this illustrative case, a universal serial bus (USB) port. Push button input 109 and data port input 110 occupy administrator interface 140, and are both illustrative types of inputs that allow an administrator, such as a manager or owner, to select and control audio messages stored on storage component 106 and the relations governed by messaging controller 108 between other signals received over inputs 102 and the messages provided in response to those signals. These administrator interface inputs 109, 110 are elaborated further below. Various embodiments may include no administrator interface inputs, or only push button input 109, or only a data port such as USB port 110 or another type of data port such as an RJ-45 socket, a coaxial cable socket, any of a variety of wireless interfaces, and other types of data interfaces currently and hereafter familiar to those in the art.

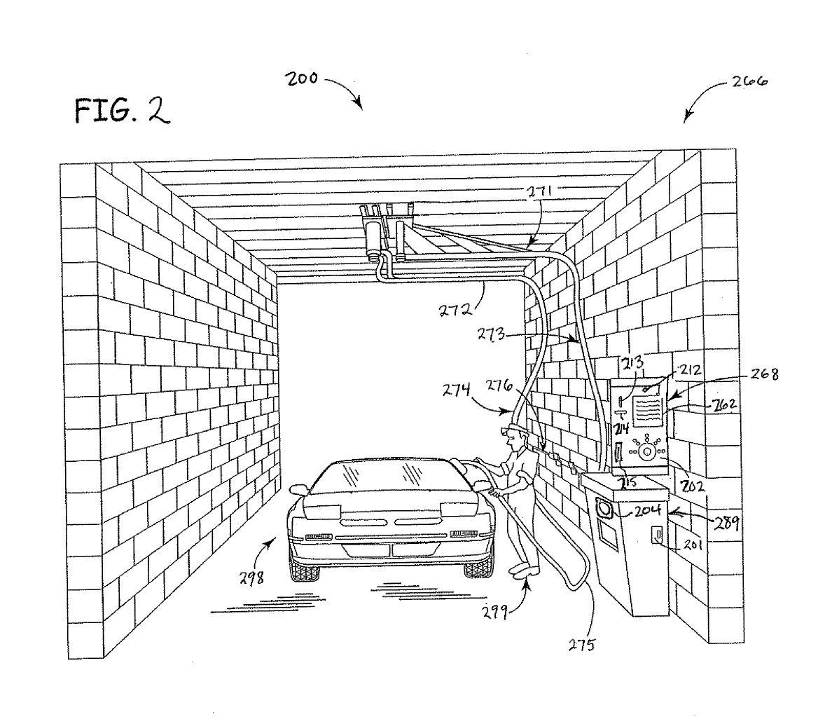

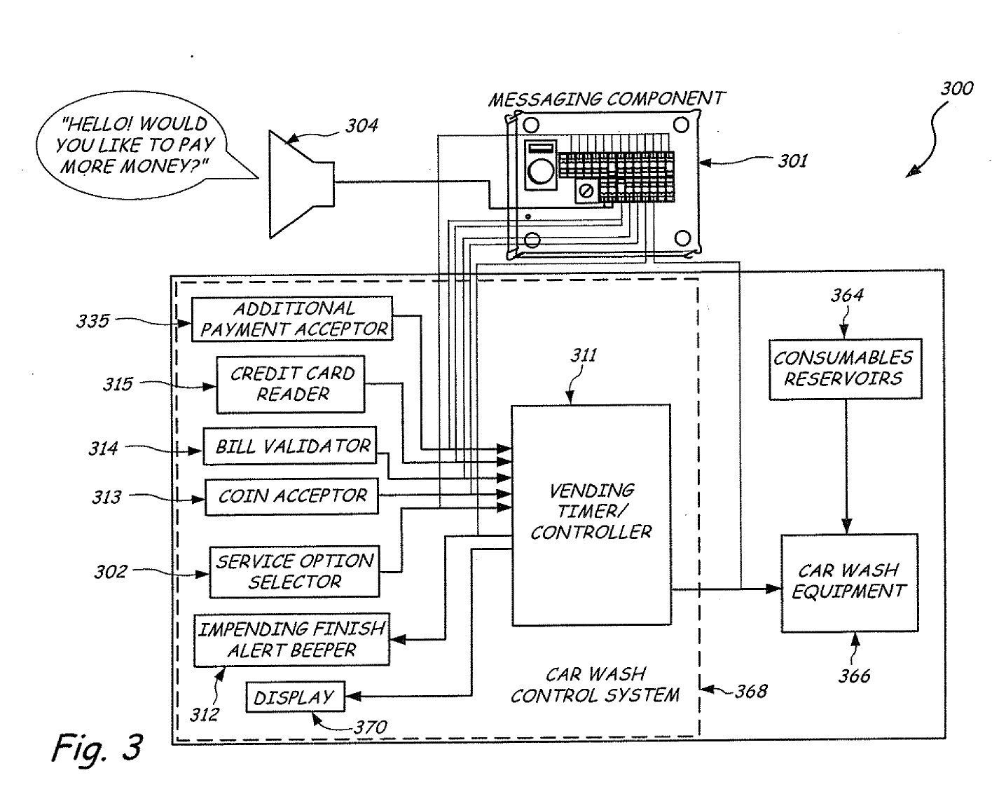

As opposed to the inputs 109, 110 of administrator interface 140, inputs 111-131 are signal inputs in this embodiment, configured to receive particular illustrative signals from a vending machine such as a car wash. The signal inputs 111-131 may be better described with reference to a car wash with which they may be usefully applied. Accordingly, car wash messaging device 100 will be further described after an introduction to an illustrative example of such a car wash, in FIG. 2 and FIG. 3.

FIG. 2 depicts an illustrative example of a car wash 200, as an example of a vending machine with which vending machine messaging device 100 may be usefully applied, in the role of a car wash messaging component 201. FIG. 3 depicts a simplified block diagram of a car wash 300 analogous to car wash 200 of FIG. 2, with a car wash messaging component 301 analogous to vending machine messaging device 100, to clarify the functioning of the car wash 200 and the vending machine messaging device 100.

According to the illustrative embodiment depicted in FIG. 2, car wash 200 includes car wash equipment 266 and car wash control system 268 in operative communication with car wash equipment 266. Car wash equipment 266 includes booms 271 and 272, hoses 273 and 274, foam brush 275, and spray gun 276. These may be connected to car wash consumables reservoirs (not separately depicted in FIG. 2) which provide water, soap, wax, clear-coat, and various other fluids and other consumables to car wash equipment 266, for example.

A customer-user 299 is depicted using the car wash equipment 266, particularly the foam brush 275 in this instance, to clean his car 298. Car wash control system 268 includes coin acceptor 213, bill validator 214, credit card reader 215, menu/service option selector 202, display 262, and impending finish alert beeper 212. Coin acceptor 213 will accept valid coins and provide a corresponding payment signal to an internal vending timer/controller (not separately depicted in FIG. 2); bill validator 214 will validate bills of currency and send a corresponding payment signal to the internal vending timer/controller; and credit card reader 215 will read credit or debit cards, in different embodiments, and upon valid payment, provide a payment signal to the internal vending timer/controller. Coin acceptor 213 and bill validator 214 may include a mechanism for confirming that the fund inputs are valid. This may include a typical security device for distinguishing genuine from counterfeit units of currency, for example, as in any of several common forms typically used in vending machines and other currency receiving devices. Additional payment acceptance components may occur in other embodiments.

Menu/service option selector 202 indicates several car wash service options from which a customer-user may choose. These service options each activate one car wash function or a combination of car wash functions. These car wash functions include, for example: engine cleaner, engine degreaser, tire cleaner, wheel cleaner, bug/tar cleaner, pre-soak, foam brush, soap, clear-coat, wax, rinse, spot-free, blow dry, vacuum, rust inhibitor, marine flush, shampoo, fragrance, pet wash, and other options. Many of these services are delivered through spray gun 276, while the foam brush option provides a supply of foaming soap through foam brush 275. Display 262 may provide information such as the amount of money deposited, and the amount of time remaining that the car wash services will be provided before the amount of time purchased runs out, for example.

Car wash 200 also includes car wash messaging component 201, which has been installed securely inside security box 289, which also has an audio loudspeaker 204 installed on the front thereof, facing into the bay of the car wash 200 aiming toward the likely position of a consumer such as customer-user 299. Car wash messaging component 201 is similar to vending machine messaging device 100 depicted in FIG. 1. Security box 289 includes a locked panel in this embodiment, and may include other mechanisms for preventing access by ordinary consumers and instead restricting access to an administrator of car wash messaging component 201, such as an owner or manager of car wash 200. Security box 289 may be shared in common with an administrator control component for the other car wash equipment 266 and/or car wash control system 268, or may be separate.

Car wash messaging component 201 may be connected with a pre-existing car wash 200, with signal connections made between car wash messaging component 201 and car wash control system 268 to assure interoperability. Car wash messaging component 201 is put through an initial learning phase after car wash messaging component 201 is installed, so that car wash messaging component 201 learns aspects of the functioning of car wash control system 268, such as how much time it activates the car wash services for relative to how much payment is received, and other aspects. To better depict this and other details of car wash messaging component 201 and its relation to the other components of car wash 200, a block diagram of a car wash analogous to car wash 200 is depicted in FIG. 3.

FIG. 3 depicts car wash 300, in the form of a simplified block diagram. Car wash 300 includes car wash equipment 366, consumables reservoirs 364, and car wash control system 368. Car wash control system 368 includes vending timer/controller 311, various payment acceptors 313, 314, 315, 335, service option selector 302, impending finish alert beeper 312, and display 370. The car wash equipment draws consumables from consumables reservoirs 364, and operates according to control signals provided by vending timer/controller 311. For example, vending timer/controller 311 may provide an “on” signal for a certain period of time corresponding to a payment deposited in one of payment acceptors 313, 314, 315, 335, according to a services purchase relation that determines how much time the car wash is engaged to be on in exchange for a certain amount of funds deposited. The control signal provided by vending timer/controller 311 may also include specific control signals for engaging specific service options with car wash equipment 366. These service options may be freely selected by a user or customer of the car wash by variously selecting from a variety of service options, using service option selector 302, in one embodiment. In other embodiments, the sequence of service options may be selected from a pre-set sequence offered by vending timer/controller 311.

Car wash 300 also includes car wash messaging component 301, analogous to vending machine messaging device 100 of FIG. 1. Car wash messaging component 301 may be connected to a pre-existing car wash 300. Car wash messaging component 301 may come in a wide variety of embodiments suitable for mating to any variety of pre-existing car wash.

For example, the car wash 300 may include a vending timer or controller 311 that provides a timer signal or control signal to car wash equipment 366 for an amount of time related to an amount of a payment that has been made. Timer input 111 of car wash messaging component 301, for instance, is configured to receive a signal from the vending timer/controller 311 of car wash 300. (Although the individual features of car wash messaging component 301 are too small for all to be clearly labeled in the depiction of FIG. 3, FIG. 3 can be viewed together with the analogous depiction of messaging device 100 of FIG. 1 to perceive the specific connections depicted between car wash messaging component 301 and the remainder of car wash 300 in FIG. 3.) Combining the depiction of messaging component 100 in FIG. 1 with the context of car wash 300 as depicted in FIG. 3 facilitates the description of the remaining elements of FIG. 1.

In the illustrative embodiments of FIGS. 1 and 3, the messaging controller 108 is configured to make a comparison of one of the signals received from the input 102 with information stored on the storage component 106. Messaging controller 108 is further configured to select from among the one or more voice messages available on storage component 106 to provide to the audio output 104, 105, based on the comparison of the signal received from the input 102 with the information on the storage component 106. The voice messages may be recordings, digital or analog, of words spoken by an actual human voice. Alternatively, the voice messages may be of a simulated voice, and the characterization of “voice” messages does not exclude alternatives that may be understood by a listener as analogous to a voiced message. The voice messages may be assembled by combining shorter voice message fragments, such as fragments with individual numbers. Audio output 104, 105 transmits these voice messages to loudspeaker 304, which translates them into sounds for a car wash user to hear, in the embodiment of FIG. 3. Other forms of output enabling other forms of messages or information perceptible to a user, such as visual display, may also be used in other embodiments. An administrator may adjust the volume of the voice messages with volume dial 103 on messaging component 100/301. Volume may also be adjusted by the controller 108 dependent on ambient noise or expected noise level attributed to a function, e.g. a vacuum.

Other than administrator inputs through the illustrative administrator control interface 140, which may comprise push button 109 and/or data port 110, messaging controller 108 may receive signals through any of the illustrative inputs 111-131 comprised in input array 102. These may include a timer signal, received through timer input 111 from a vending timer or controller 311 of car wash 300; an impending finish alert beeper signal, received through beeper input 112 from an impending finish alert beeper 312 of car wash 300; a payment signal, received through any of the illustrative payment inputs 113, 130, 114, 115; a service option selector signal, from any of the service option selector inputs 116-128; or a security signal, via security input 129, in this illustrative embodiment.

A payment signal may be received from coin switch input 113, 130, from coin acceptor 313 of car wash 300; through dollar switch 114, from bill validator 314 of car wash 300; or through extra payment switch 115, from either credit card reader 315 or illustrative additional payment acceptor 335 of car wash 300. Additional forms of payment acceptors may include acceptors of debit cards, credit cards, prepaid cards associated with the car wash, tokens, wireless fund transfers, etc.

In one embodiment, vending timer/controller 311 is configured to receive pulse signals from coin acceptor 313 or bill validator 314, as one mechanism for an input representing a payment to be received and an output generated responsively thereto. Bill validator 314 is configured to receive a paper currency bill, whereby the bill is verified as legal tender, upon which a series of electrical pulses is outputted, forming a signal representing the denomination of the currency bill inserted. Coin acceptor 313 is a device in which a coin is inserted, whereby the coin is verified as legal tender, upon which a series of electrical pulses is outputted, forming a signal representing the denomination of the coin inserted. For example, the pulses may each represent a payment signal of 25 cents, so that a quarter received in the coin acceptor 313 generates a payment signal of a single pulse, a one U.S. dollar bill received in the bill validator 314 will result in a payment signal of four pulses, and a five dollar bill received in the bill validator 314 will result in twenty pulses. Or in an alternative embodiment, variations may be made depending on type of payment, so that, for instance, a five dollar bill will result in twenty-two pulses, thereby including a bonus value. A payment made with a credit or debit card using credit/debit card reader 315 may also be transmitted as a series of pulses, one for each multiple of 25 cents in the payment. Alternatively, coin acceptor 313 may be configured to receive and validate prepaid tokens, for example.

Car wash control system 368 incorporates a non-resetable counter and a display 370 as an auditing function to verify the currency count, in this embodiment. Vending timer/controller 311 accumulates the value of the received pulses and translates those payment signals into the value of the products or services to be dispensed; for example, the duration of time for the car wash services to be dispensed, in this embodiment.

In one embodiment, the services to be dispensed, such as soap, rinse, wax, etc., may each be dispensed for variable periods of time, as the user selects from among them while the timer runs down. In this embodiment, the pulses representing payment signals cause vending time to accumulate in the vending timer/controller 311, so that additional pulses increase the duration of time for which the soap or wax are dispensed, for example. The payment may be made in several increments, such as a number of coins, prior to beginning the timer for the car wash services to be dispensed; the vending timer/controller 311 may also accept additional payments while the services are in progress and the timer is running down, to add additional service time.

The service option selector signals may be received by car wash messaging component 301 through any of the service option selector inputs 116-128, all of which may be received from corresponding service options selected for via service option selector 302 of car wash 300. These service options may be included in a control signal relayed by vending timer/controller 311 to car wash equipment 366, causing the corresponding particular equipment among car wash equipment 366 to engage. These service option signals provided by service option selector 302 include an engine cleaning option signal, that car wash messaging component 301 is configured to receive at engine cleaning input 116; a tire cleaning option signal, that messaging component 301 is configured to receive at tire cleaning input 117; a bug-tar cleaning option signal, that messaging component 301 is configured to receive at bug-tar cleaning input 118; a pre-soak option signal, that messaging component 301 is configured to receive at pre-soak input 119; a foam brush option signal, that messaging component 301 is configured to receive at foam brush input 120; a soap option signal, that messaging component 301 is configured to receive at soap input 121; a clear-coat option signal, that messaging component 301 is configured to receive at clear-coat input 122; a wax option signal, that messaging component 301 is configured to receive at wax input 123; a rinse option signal, that messaging component 301 is configured to receive at rinse input 124; a spot-free option signal, that messaging component 301 is configured to receive at spot-free input 125; a first extra service option signal, that messaging component 301 is configured to receive at first extra cleaning input 126; a second extra service option signal, that messaging component 301 is configured to receive at second extra cleaning input 127; and a third extra service option signal, that messaging component 301 is configured to receive at third extra cleaning input 128. It is a fairly common alternative for a service option selector to provide a single engine/tire cleaner. In this case, the engine/tire cleaner signal is received via engine cleaner input 116 and identified as an engine/tire cleaner signal. The first through third extra option inputs may facilitate the versatility and use of the messaging component, as indicated by a specific example of their use, as follows.

In a particular illustrative example, each of extra option inputs 126, 127, 128 have a default input setting, and an option to change from the default to a different message, which an administrator may do using an administrator interface 140. In this illustrative example, the default option for the first extra signal input 126 is for a vacuum option signal; the default option for the second extra signal input 127 is for a shampoo option signal; and the default option for the third extra signal input 128 is for a fragrance option signal. Each of the service option inputs 116-128 may be usefully applied to washing and caring for a car. For each of the service option inputs 116-128, a signal for a particular service option provided by the service option selector 302 is received only by an input on messaging component 301 that is indicated to receive the signal for that particular service option, in this illustrative embodiment.

Car wash messaging component 301 includes messaging controller 108, which is in operative communication with the inputs 109-129 through bus 132. Messaging controller 108 is also in operative communication with storage component 106, and is thereby configured to compare the uniquely identified input signals it receives from the input elements 102 with the information stored on storage component 106, such as previously recorded correlations between the fund inputs and the car wash control signal. Messaging controller 108 is thereby enabled to respond to a particular input by providing a response, in the form of a voice message, that corresponds to that input, and that may provide information related to that input. For example, messaging controller 108 is configured to respond to a subsequently received payment signal that matches a previously recorded payment signal by providing, via the output 104, 105, information about the vending transaction indicated by the vending control signal that corresponds to the subsequently received payment signal. This information can take the form of messages that include an indication of the period of time for which the one or more car wash functions is provided in response to the one or more payments.

Such a correspondence between input and voice message to be provided may be based on a correlation that is defined as a default in messaging component 301, and that is incorporated in messaging component 301 prior to its delivery to the end user (although such defaults may be changed in some embodiments). The correlation defining the voice message to be provided based on a particular input may also be defined, in whole or in part, by the end user through the administrator interface 140. In yet another option, the relation may also be defined, in whole or in part, by previously received non-administrator inputs, such as inputs from the timer input 111, the beeper input 112, and/or the payment inputs 113, 130, 114, 115.

For example, the messaging controller 108 may be configured so that it responds to receiving a signal from the input 102 by providing a voice message that provides information related to that input, and provides that voice message to the audio output 104, 105. Thus, if the messaging controller 108 receives a signal from the timer input 111, it may respond by selecting a voice message providing information related to vending timer 311 of car wash 300, such as the amount of time remaining for the car wash services to be dispensed, in response to receiving a signal via timer input 111 from vending timer 311. In some car washes, for example, it is typical for the output from the timer to be a 24 volt signal; in corresponding embodiments, messaging device 100 or messaging component 301 may be adapted for the timer input 111 to receive and monitor a 24 volt signal. As a few illustrative voice messages that messaging device 100 or messaging component 301 might provide, it may respond to first receiving a signal through timer input 111 by providing a voice messaging saying “greetings”; and it may respond to the timer signal ending by saying “thank you; please come again soon”, or “thank you; don't forget to vacuum too”, among other possible messages. As yet another example, messaging controller 108 may provide a message as a function of signals from multiple inputs; such as, if a signal is being received via timer input 111 but all signals have stopped from service option inputs 116 through 128, the messaging controller 108 may provide a voice message that says “stopped”, or “please make a selection from the service option menu”, which provides the information that the services are stopped and that the user must make a selection if one service or another is to be provided. It may also respond to the end of a timer signal by providing a cross-marketing message with information on additional vending machines or other products or services available nearby. For example, messaging controller 108 may provide a message such as “don't forget to pick up an air freshener in the lobby” or “stop inside the store and check out our sales on refreshing beverages”.

As another example of the responses of messaging controller 108, if the messaging controller 108 receives a signal from the impending finish alert beeper input 112, it may respond by providing a voice message with information related to impending finish alert beeper 312 of car wash 300, such as that the dispensing of the car wash services has little enough time left that it is close to being finished. This impending finish alert signal may also be adapted or learned as a prompt in response to which the vending controller 311 provides one of the ending-type messages discussed above. This impending finish alert signal may have been sent by vending timer/controller 311 to impending finish alert beeper 312 within car wash control system 368 after being triggered in vending timer/controller 311 by a preselected threshold time, perhaps 30 seconds or one minute, for example, being met by the timer. While such a beeper may create a simple sound alert such as by beeping, with no other information, the messaging component 301 also allows that signal to be used to prompt a responsive audio voice message containing further information, such as an intermittent countdown of the remaining time, how much money must be added to gain additional time on the timer, or other information. Or it may simply provide a voice message saying “please deposit more money to continue” or “would you like to pay more money to continue service?” This would provide the information that additional services are available to purchase. It may also provide additional information, such as how much money would be required for an add-on service, or the availability of a bonus rate, for example.

As yet another example of the responses of messaging controller 108, if the messaging controller 108 receives a signal from the coin input 113, 130, the bill input 114, or the extra payment input 115, it may respond by providing a voice message providing information related to coin acceptor 313, bill validator 314, credit card reader 315, or additional payment acceptor 335 of car wash 300, such as information regarding payment. It is typical in some car wash systems, for example, for a payment signal to take the form of a 50 millisecond electrical pulse. In other car wash systems, for example, it is typical for a payment signal to take the form of a 60 hertz electrical pulse. Different embodiments of a messaging device 100/301 may be adapted to receive either or both of these signals, and/or other signals, at coin input 113, 130, bill input 114, and extra payment input 115. If a vending machine messaging device 100/301 is being newly provided to a pre-existing car wash 300 or other vending machine, the inputs are also connected to the signal lines in car wash 300 by appropriate means that is conductively connected to the original signal line and allows the voltage (for instance) on the original signal line to be transmitted along a new signal line to the particular input on vending machine messaging device 100/301 as well.

As an example, the voice message may respond to any payment being made by confirming the amount of the payment, by announcing the total funds deposited thus far, or by announcing how much additional money must be deposited for a certain service package. It may also offer a suggested service package to the user that is of greater value than a service already selected by the user, and announce how much additional payment must be made to purchase the more valuable service package. As additional examples, the messaging device 301 may respond to an initial payment signal simply by providing a voice message saying “greetings!”, which would provide the information indicating that the car wash 300, and the respective payment acceptor in particular, are functioning properly. The input may also be connected to a component that is capable of detecting the presence or the approach of a customer or potential customer, such as a proximity sensor or detector connected to proximity input 131, and that therefore provides a signal indicating the arrival of a new customer. This may prompt the messaging controller 108 to provide a responsive message including a greeting and an invitation to deposit a payment and select a car wash service function.

As still another example of the responses of messaging controller 108, if the messaging controller 108 receives a signal from the administrator interface 140, such as from administrator push button 109 or administrator data port 110, it may respond by providing a voice message providing information related to the signal from the administrator interface, such as information about options selected via the administrator interface 140. For example, in one embodiment, administrator interface 140 includes only a push button 109, and a variety of administrator options may be selected by pressing push button 109 in repeated sequences to issue coded instructions to messaging device 100/301. The messaging controller 108 may immediately begin to provide voice messages related to the input received via push button 109 by providing voice messages such as “one”, “two”, “three”, of the number of times the push button 109 has been pressed in sequence. A sequence is ended and a coded entry is made by holding the push button 109 down for five seconds after pressing it a given number of times for a chosen code; a voice message such as “option entered” is provided after the five seconds, to inform the administrator that the option has been entered. A more specific voice message may also be provided to confirm what option the administrator has selected.

For example, in one particular embodiment, the push button 109 is used to select service option messages to assign to first, second and third extra service option inputs 126, 127, 128. Voice message assignments for first extra service input 126 are engaged by first holding the push button down for five seconds, after which a voice message may be provided that says “administrator selection engaged; please select a voice message to assign to first extra service input”. Voice message assignments for the second extra service input 127 are engaged by first pressing the push button 109 briefly and then holding it down for five seconds; voice message assignments for the third extra service input 128 are engaged by first pressing the push button 109 briefly, twice, and then holding it down for five seconds. Once the administrator selection is engaged for whichever of the extra service inputs, a variety of previously recorded extra service messages stored on storage component 106 are provided; a first one is played, and if the button 109 is pressed, another voice message option is played, going in sequence through all available pre-recorded extra service voice message options. A particular voice message may be chosen and assigned to first extra service input 126 if the push button 109 is held down for five seconds, beginning within five seconds after the completion of one of the voice message options, in one embodiment; otherwise, it proceeds to the next voice message option in the queue. In another embodiment, pressing the push button is required to advance to the next sample voice message in the queue, and if it is not within five seconds after a message is provided, then that message becomes assigned as the new default.

For example, the first extra service input voice message may be “vacuum”. The next may be “shampoo”. The subsequent messages may be “fragrance”, “wheel cleaner”, “wash”, “rapid dry”, “super wheel cleaner”, “triple foaming conditioner”, “premium clear coat protectant”, “tire dressing”, “rubber and vinyl protectant”, and “tri-foam”, for example. Each time push button 109 is briefly pressed, it will proceed to announce the next voice message option in the queue. If the push button 109 is briefly pressed again after the last message in the queue, then it will cycle back to the first. If instead push button 109 is held down for five seconds, beginning during or for five seconds following the announcement of one of the voice messages, then that voice message will be assigned to that extra service input, from among extra service inputs 126, 127, 128, in one embodiment. The messaging controller 108 will then provide a voice message such as “you have selected the following message for the first extra service input:” and then announce the selected message, such as “triple foaming conditioner”.

The three extra service inputs may be assigned default settings from among the listed options available for assignment. For example, in one embodiment, the default settings are set as the “vacuum” message for first extra service input 126; the “shampoo” message for second extra service input 127; and the “fragrance” message for third extra service input 128.

Different voice message options may also be selected and assigned to be provided responsively to the other inputs. For example, a variety of different greeting messages and concluding messages may be stored on storage component 106, and particular ones may be provided via audio output 104, 105 based variously on the payment inputs 113, 130, 114, 115, the timer input 111, or the impending finish alert beeper input 112, for example. A greeting message may be provided responsively either to a first signal being received through any of coin input 113, 130, bill input 114, or credit card 115, for example; or alternatively, a first signal received through timer input 111. A concluding message may be provided responsively either to the signal through timer input 111 ending, for after passage of the appropriate time after a signal received from impending finish alert beeper input 112, for example. Additionally, a series of greeting messages or concluding messages may be added together in sequence. New voice messages may also be recorded by the administrator via microphone 160, or other recording means in other embodiments, making appropriate commands via administrator interface 140, and added to an appropriate queue on storage component 106.

For example, in one embodiment, messaging component 100/301 stores a variety of options each for a greeting part one, a greeting part two, and a concluding message. For example, the options for the greeting part one may include both “greetings!” and “hello!”, among other choices. The options for the second part of the greeting may include “please deposit two dollars for an initial four minutes of car wash time” and “thank you for using John's car wash”, among other options—the latter of which would likely have been custom recorded by the administrator, or custom ordered when the messaging component 301 is ordered, due to its specificity. The concluding messages may include “thank you!” and “thank you for your business!” and “would you like to deposit more money for additional car wash time?”, for example. The administrator may also be able to record additional voice messages for these or other messages to be assigned to other inputs, in one embodiment.

In this embodiment, option assignment for the first greeting part may be opened by briefly pressing push button 109 three times and then holding it down for five seconds. The voice message options may then be cycled through; as each option plays, the next option may be skipped to by briefly pressing the push button 109, while the current option can be assigned by holding the push button down for five seconds beginning either during or in the five seconds after that voice message option is played. The second greeting part and the concluding message can also be cycled through and selected for assignment in a similar fashion; option assignments for the second greeting part may be opened by briefly pressing the push button 109 four times and then holding it down for five seconds, while option assignments for the concluding message may be opened by briefly pressing the push button 109 five times and then holding it down for five seconds.

Some or all of the pre-recorded messages stored on storage component 106 may also have corresponding messages stored in languages other than the default language. For example, in one illustrative embodiment, the default language is English, and an option for Spanish is also available, with parallel prerecorded voice messages in Spanish stored on storage component 106. In this illustrative embodiment, language option assignment can be opened by briefly pressing push button 109 six times and then holding it down for five seconds, to which the messaging controller may respond with the message “language selection opened; selección de la lengua abierta”. This may be followed with a voice message announcing, in both available languages, the default setting: “English; inglés”. If the push button is then briefly pressed, the next voice message in the queue is announced: “Spanish; español”. If the push button is briefly pressed again, the messaging controller will provide the next voice message in both languages: “English and Spanish; inglés y español”. If the push button is briefly pressed again, it will cycle back to “English; inglés”. If the push button 109 is held down beginning during or within five seconds after any of these messages, the messaging controller will inform the administrator of the selection with a voice message; for example: “You have chosen to play all messages in both English and Spanish. Usted ha elegido jugar todos los mensajes en inglés y español.” Many other languages may be included in other embodiments.

As yet another example of the responses of messaging controller 108, the messaging component 301 may record signals from input 102 on storage component 106. Messaging controller 108 may further record a previously existing correlation between amount of payment and the duration of time the car wash services are provided relative to that amount of payment, in a car wash 200 or car wash 300 to which messaging component 100/201/301 is connected. In this case, for example, car wash 300 may be pre-existing without messaging component 301, and its owner may newly introduce car wash messaging component 301 and interconnect it with car wash 300. This may include connecting some or all of the signal lines depicted in FIG. 3 to be connected to car wash messaging component 301 as well as to the signal lines leading from service option selector 302, coin acceptor 313, bill validator 314, credit card reader 315, and additional payment acceptor 335, as well as the timer signal line leading from vending timer/controller 311 to car wash equipment 366 and the signal lines leading from vending timer/controller 311 to impending finish alert beeper 312 and display 370. Once connected, the messaging controller 108 may record one or more signals received from input 102, collectively including the inputs through which any or all of the components of car wash 300 are connected, and store these signals, including ancillary information such as which input the signal was received through and how long the signal lasted, on storage component 106. This may be useful for comparing signals received thereafter to signals stored on storage component 106.

Through this means, the messaging component 301 is configured to learn, for example, how long of a timer signal—and how much time the ear wash services are engaged—compared to a particular amount of payment. For example, in one embodiment, after it has been installed in connection with car wash 300 and set by an administrator through administrator interface 140 into a learning mode, messaging component 301 receives payment signals via coin input 113, 130 corresponding to a payment of two U.S. dollars, and subsequently receives a timer signal via timer input 111 that lasts for four minutes, then ceases. Messaging controller 108, acting in learning mode, responds to these inputs by recording on storage component 106 a relation between a payment of two dollars and a timer signal of four minutes. Later, the messaging component 301 is taken out of learning mode and restored to normal operating mode, and it again receives payment signals, through one of the payment inputs 113 through 115, indicating a deposit of two U.S. dollars. Messaging component 301 then responds to this payment input by selecting corresponding voice messages from storage component 106 with information on the anticipated four minute timer duration, to provide to audio output 104, 105, based on the comparison between the earlier-recorded correspondence between a two dollar payment and a subsequent four minute timer signal. For example, the corresponding voice messages may include a message that says “thank you for depositing two dollars. You have four minutes of car wash service time available.” It may follow this up during the running period of the timer, for example, by waiting until three minutes after the timer has begun and providing another voice message that says, for example, “you have only one minute remaining. Would you like to pay more money to receive additional service time?” It may provide another, similar signal at three and a half minutes after the timer has begun and at three minutes forty-five seconds, providing voice messages with information on the remaining time and on additional options the user might want to take advantage of.

One embodiment also includes additional voice messages that provide useful information on the timer status based on the initial comparison of payment signals with a pre-recorded relation between payment and time, including suggestions for using additional available car wash service options at various intervals during the timer duration. For instance, after receiving the payment component, the messaging component may announce after one minute, “you have three minutes remaining; you may want to remember to use tire cleaner”; or, “you have two minutes left; don't forget to leave time to wax and rinse”; or, “You have 45 seconds remaining; would you like to use the quick dry?”

The messaging controller 108 may also be trained to learn different rates of pay for different car wash purposes. For example, during the learning mode, messaging controller 108 may first receive from car wash 300 via input 114 a signal representing a payment of two dollars, then receive via input 123 a signal representing a wax function purchased with the two dollars. The wax signal may end after one minute, indicating that the wax function is provided for one minute in response to the payment of two dollars. Messaging controller 108 records the indication that two dollars purchases one minute of time for the wax function to be made available. Then the messaging controller 108 may receive another signal via bill input 114 representing another two dollar payment, and this is followed by a signal via input 124 indicating that a rinse is selected. Input 124 may detect an indication that the rinse ends after four minutes, so messaging controller 108 records an indication that a two dollar payment yields four minutes worth of rinsing time. In one embodiment, a user can later switch back and forth freely between different car wash functions, including wax and rinse, and the car wash will continually run down its timer at different rates depending on which car wash function is being used, with the timer running down at four times the rate on wax as on rinse. In this illustrative embodiment, the messaging device 301 is configured to track the changes in selected car wash functions and provide messages that include indications of the period of time, such as how much time is remaining, as different functions at each of the different rates it has learned are chosen.

Through such voice messages as those variously described above, car wash messaging component 301 is enabled to respond to signals from car wash control system 368 by providing corresponding voice messages with information about the car wash 300 to a user, thereby providing a consumer with a superior car wash experience by providing a variety of useful information that makes operating the car wash 300 easier and more convenient. A customer-operator is enabled to wash his car with ongoing indications of the time remaining, of services available and suggestions for services to use, information on how much additional payment would be required to extend the time period for the car wash services to be dispensed, and a variety of other useful information, without having to interrupt the attention he devotes to washing his car in order to try to track such information through less convenient means, among other advantages.

Returning to the other features of messaging device 100/301, another feature is available in one embodiment, which would allow the administrator to listen to all messages stored on storage component 106 in one sequence. This is activated by briefly pressing push button 109 eight times in a row and then holding it down for five seconds, in one embodiment.

The messaging device 100/301 receives power through power input 150, which has its circuit completed through input 152. In one embodiment, as labeled on vending machine messaging device 100 in FIG. 1, messaging device 100 is adapted to be powered by a 24 volt alternating current (24 VAC) power source, with input 150 connected to 24 VAC hot, and input 152 connected to 24 VAC common. This is one example of a power source that is likely to be available in a significant number of car washes; messaging controller 100/301 is adapted to use other power sources in other embodiments.

Input 129 serves the purpose of a security alert. For example, it may be connected in a closed circuit to the 24 VAC hot source, and the alert triggered if that circuit is broken. Messaging controller 108 may respond to this by sounding an alarm; or, in another embodiment, by providing a high-volume voice message that says, for example, “warning; please do not tamper”.

In another embodiment, for example, all of the voice messages corresponding to all of the inputs are default settings that may be replaced by new assignments via the administrator interface 140. This may be particularly useful, as one example, for use in a region dominated by a language that is not supported by a provider of the messaging device 100/301.

Of course, a variety of other systems for allowing the administrator to control messaging device 100/301 exist in other embodiments. For example, in embodiments that include a data port, the data port may be used to connect a hand-held device, a laptop computer, or other device over a local, network, Internet, or other connection. These allow the administrator interface to include a more sophisticated, graphical application for manipulating the control of messaging device 100/301, and may be applied in various embodiments.

Voice message assignments for the inputs, the number of inputs, the types of inputs, and the types of administrator interface, along with other features, may also be pre-set according to a customer's preselected, custom settings for a vending machine messaging device that is pre-ordered by that specific customer, in another embodiment.

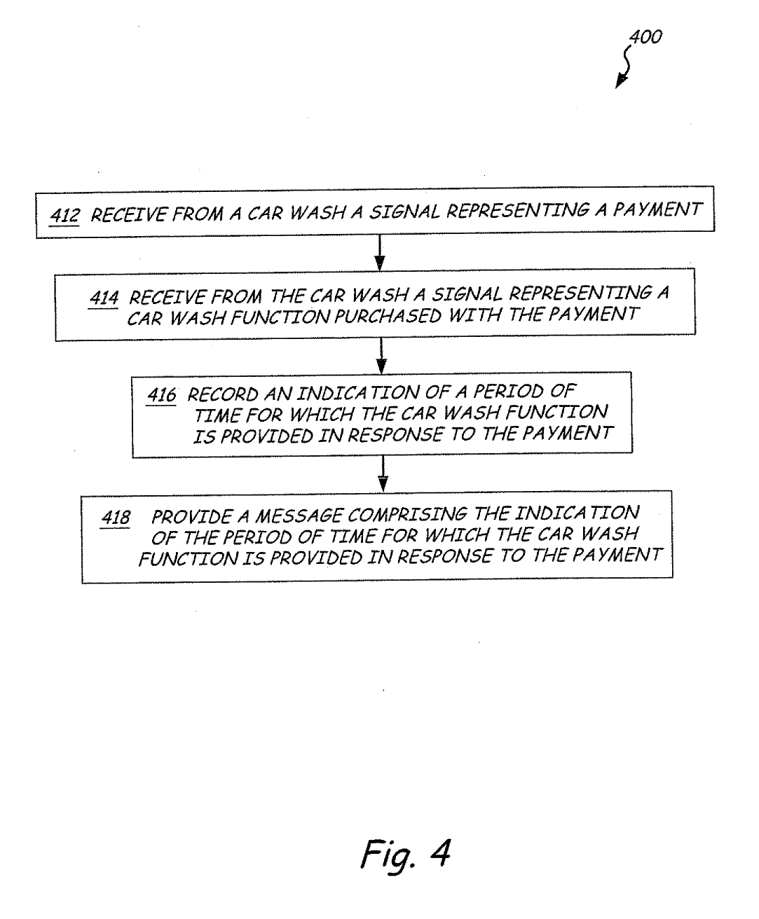

FIG. 4 depicts a flowchart 400 that describes a method for providing information to a user of a car wash 200, 300, corresponding to one embodiment. The method 400 includes step 412, receiving from a car wash a signal representing a payment; step 414, receiving from the car wash a signal representing a car wash function purchased with the payment; step 416, recording an indication of a period of time for which the car wash function is provided in response to the payment; and step 418, providing a message comprising the indication of the period of time for which the car wash function is provided in response to the payment. The message may be provided, for example, in response to receiving a signal indicating a customer's presence, or to receiving a signal representing a payment, subsequent to the learning mode. The message may include information about an additional car wash function and the additional payment required to purchase the additional car wash function, such as by making a suggestion of switching to the rinse or wax function if the wash function is still being used when time is running low, or by making a suggestion to deposit an additional payment, along with information on time remaining or additional time to be gained by depositing an additional payment. The messages may take the form of voice messages provided from a storage component in communicative contact with the messaging controller 108.

Making reference to the earlier figures, for example, if a timer signal is received from the timer input 111 of input block 102, then a voice message may be provided with information about the timer. For example, a timer message may be received which indicates that a five minute duration of car wash service time has begun; a voice message may be provided that says, “your five minutes of service have begun”. As another example, a timer signal may end, or a signal may be received indicating that the timer has just ended. A responsive voice message may be provided that says, “please deposit additional funds if you would like to continue using the car wash. Thank you for your business”.

If an impending finish alert beeper signal is received from the beeper input 112 of input block 102, then a voice message may be provided with information related to the impending finish. For example, an impending finish alert beeper signal may be received thirty seconds prior to the end of a car wash timer expiring. A responsive voice message may say, “you have thirty seconds remaining. You may purchase an additional thirty seconds of service time by depositing one quarter”, thereby providing useful information on the impending finish, as well as on one option on how to delay that finish, if desired.

If a service option signal is received at any of service option inputs 116 through 128, then a voice message related to the service options may be provided. For example, a voice message may be provided simply confirming the service that has been selected, to assure the user that the fluid coming out of the fluid dispensing spray gun 276 is what is desired. So, a signal detected via presoak input 119 may prompt a voice message that simply announces, “presoak selected”, and a signal received via clear-coat input 122 prompts a voice message that announces, “clear-coat selected”. As another example, if a signal is received via soap input 121 with three minutes to go, but no signal is received via another input by the time of only one minute remaining, a voice message may be provided that says, “one minute remaining. Don't forget to make time to rinse and wax”.

If a service option signal is received via the inputs of administrator interface 140, such as via push button 109, then a voice message with information related to the administrator input is provided. For example, if an administrator selects to assign the messaging component to play all voice messages in both English and French, a voice message with information confirming this selection may be provided: “You have chosen to play all messages in both English and French. Vous avez choisi de jouer tous les messages dans l'anglais et le Français.” Or, if the administrator cycles through the available languages to discover which ones are available, a series of voice messages may be provided with the information on which languages are available in that unit. As another example, an administrator may enter a selection to put the messaging component 301 in learning mode when first connected to a legacy car wash 300, then enter a request for the learned relations between payments and timer durations to be played back to the administrator, then put the messaging component 301 into normal operating mode. Messaging component 301 may respond to these commands, respectively, by providing voice messages that say, “learning mode engaged”; “payment of two dollars corresponds to four minutes of service time”; “payment of twenty-five cents prior to the end of a service time adds thirty seconds of service time”; “payment with a five-dollar bill corresponds to eleven minutes of service time”; “normal mode engaged; ready for consumer interaction”, as illustrative examples.

If payment signals are received via the payment inputs 113, 130, 114, 115, together with corresponding timer signals via timer input 111, then information on the payment signal and corresponding timer signal may be stored on storage component 106. This would be the case if messaging component 301 is in learning mode, for example. Later, with the messaging component in normal operating mode, if it receives a subsequent payment signal that matches the stored payment signal, it may respond by providing information related to the corresponding timer signal and its known relation to the received payment signal. This may take the form, for example, of providing information on the amount of car wash service time made available by the deposit of the payment corresponding to the received payment signal. As one possibility, this may mean that a stored relation indicates that a three dollar payment corresponds to a six minute timer signal, and the messaging component 301 receives a later signal for three dollars worth of payment before the car wash services are engaged. The messaging component may then respond by providing a voice message that announces, “you have deposited three dollars. You have six minutes of car wash service time available. If you wish to add additional time later, you may add thirty seconds per twenty-five cents entered”. This provides information to confirm the user's payment, assure the user of the duration of time purchased, and to suggest additional payment by incorporating information on the terms for additional service time that may be purchased.

A vending machine messaging device similar to vending machine messaging device 100 may be applied to other vending machines besides a car wash like car wash 200 and car wash 300, which are illustrative of a much greater variety of applications. For example, other embodiments of a vending machine messaging device may be usefully applied for any products and services available in variable quantities. Typical products and services to which embodiments of a vending machine messaging device may be usefully applied may include, but are not limited to, items such as: blown air, compressed air, vacuum, water, pay shower time, soap, wax, sealant, coatings, fragrance, shampoo, chemicals, food items, beverages, ice, feed, grain, fuel, gasoline, petrol, diesel, oil, grease, lubricant, heat, cold, radiant energy, helium, oxygen, pay phone time, satellite time, cable time, Internet time, chat room time, computer time, tanning bed time, tanning oil, lotion, cosmetics, message time, hair dryer time, exercise equipment time, radio listening time, jukebox time, TV time, pay-per-view time, video game time, game time, ride time, gambling time, gambling/gaming machine credits, slot machine credits, commodities, location or event admission, toll booth passage, for example, in addition to other products or services.

Additional objects, features, and advantages of the present invention may be discerned through the corresponding description and figures, and inferred by those in the art from the general teaching of the present disclosure and in the course of practicing, manufacturing, using, and otherwise experiencing different embodiments, as defined by the appended claims.

It can thus be seen that different embodiments such as those disclosed herein provide significant advantages over current systems. These are indicative of a few of the various additional features and elements that may be comprised in different embodiments corresponding to the claims herein. Although particular illustrative embodiments have been selected for detailed description, workers skilled in the art will recognize that changes may be made in form and detail without departing from the spirit and scope of the invention. Various examples disclosed herein provide initial indications of the further variety of embodiments. These examples are intended to be illustrative, and do not imply the exclusion of any additional embodiments of the present invention.

As a particular example, while the descriptions above made substantial use of an embodiment in which car wash functions are provided to hand-held implements that a user uses to manually apply to his car, the present invention is not limited to such embodiments, and additional embodiments are equally applicable in which a customer remains in her car while car wash functions are automatically applied, and audio messages are provided to the customer in her car. Such audio messages may be emitted by speakers in the car wash facility, for example, or through interactive audio messages provided to a handheld device or a dashboard device in the customer's car. This may be particularly applicable for applications in which the customer provides payment for the car wash through a handheld device, such as a cellphone or personal digital assistant. As another particular example, while the descriptions above made substantial use of the example of a car wash embodiment, the present invention is not limited to such embodiments, and a wide variety of applications involving other types of vending systems are likewise encompassed by additional embodiments, the elements of which will be appreciated by those skilled in the art from the present disclosure.

1-20. (canceled)

21. A messaging component for coupling to pre-existing car wash controller, comprising:
at a payment sense input configured to couple to a car wash payment input of the car wash controller, the car wash payment input related to money payment by a customer;
a service type input configured to couple to a service option selector of the car wash controller, the service option selector related to a car wash service selected by the customer;
an impending finish alert input configured to couple to an impending finish alert from the car wash controller, the impending finish alert output providing a signal to the customer that a car wash timer is about to expire; and
the messaging component controller configured to learn a relationship between the money payment, the service option selector and the impending finish alert and responsively provide a verbal language output.

22. The messaging component of claim 21 wherein the messaging component controller is further configured to assign a time value to a selected service option.

23. The messaging component of claim 22 wherein the service option selector is configured to select between a plurality of services and the messaging component controller is configured to assign a plurality of time values to the plurality of services.

24. The messaging component of claim 21 wherein the messaging component controller includes a memory configured to store the verbal language output.

25. The messaging component of claim 21 wherein the messaging component controller includes a programming input for use in assigning the verbal language output to a selected service option.

26. The messaging component of claim 21 wherein the messaging component controller includes a programming input for use in assigning the verbal language output to information which indicates an amount of time remaining.

27. The messaging component of claim 21 including a microphone configured to receive verbal messages for use by the verbal language output.

28. The messaging component of claim 21 wherein the car wash payment is related to money provided by the customer.

29. The messaging component of claim 21 wherein the car wash payment is related to credit card information provided by the customer.

30. The messaging component of claim 21 including a car wash control sense input configured to couple to a car wash control output from the car wash controller which is used to selectively control car wash equipment.

31. The messaging component of claim 30 wherein the messaging component controller is further configured to provide the verbal language output as a function of the car wash control output.
